(19) United States
(12) Patent Application Publication
(10) Pub. No.: US 2026/0328159 A1
(43) Pub. Date: Oct. 22, 2026

(54) Power Generation System with Agitated Plasma-energization Equipment

(71) Applicant: SHIH-YUAN KE, Chia Yi Hsien (TW)

(72) Inventor: SHIH-YUAN KE, Chia Yi Hsien (TW)

(21) Appl. No.: 19/651,317

(22) Filed: Apr. 17, 2026

(30) Foreign Application Priority Data
Apr. 22, 2025 (TW) 114115210

(51) Int. Cl. F02G 3/00

(52) U.S. Cl. CPC F02G 3/00

(57) ABSTRACT

A power generation system comprises an agitated plasma-energization equipment and a power generator connected to the agitated plasma-energization equipment. The agitated plasma-energization equipment includes a furnace including an internal processing space and a gas collection channel intercommunicating with the internal processing space; a heating module disposed on the furnace to heat the internal processing space; and a gas flow guiding device disposed in the internal processing space. The gas flow guiding device includes a first tube and a second tube. Each of the first and second tubes has multiple through holes disposed in a sidewall thereof. The first tube is mounted around the second tube. The first tube and the second tube have a gap therebetween. Gas inside the furnace is collected through the gas collection channel and is discharged as a first gas. The first gas is transmitted into and combusted in the power generator for generating electric energy.

### BACKGROUND OF THE INVENTION

The present invention relates to a power generation system and, more particularly, to a power generation system with an agitated plasma-energization equipment.

With rising of environmental awareness, the green industry is gradually receiving worldwide attention. Using green energy/renewable energy friendly to the environment is the development trend of current and future technology, particularly for reducing negative impact to the environment and reducing emission of greenhouse gas during the power generation process. Currently applicable power generation methods using green energy generally include solar power generation, wind power generation, hydroelectric power generation, tidal power generation, geothermal power generation, and biomass energy generation which is different from other power generation methods using the natural energy.

The generation process of biomass energy involves conversion of organic matter derived from organisms into thermal energy. Resources of biomass materials for power generation are numerous, and many resources may be obtained from general trash and biomass waste in waste materials. Therefore, if the biomass can be effectively used to generate power, aside from reduction of trash and waste materials in the environmental issue, effects including highly effective and stable power generation of green energy in a pollution-free or low-pollution manner can be achieved. Furthermore, the ashes generated after the procedure of converting the biomass materials into thermal energy can be recycled to form material for fixed carbon capable of fixing carbon, such as forming green carbon, blue carbon, or yellow carbon. Thus, the carbon dioxide is converted into organic compounds to achieve the effect of removing carbon dioxide, thereby reducing the concentration of carbon dioxide in the atmosphere to slow down the global warming effect while increasing the capacity of absorption and storage of carbon in the entire ecosystem. However, the conventional technology lacks a complete biomass power generation system.

Thus, improvement to the conventional biomass energy generation technology is necessary.

### BRIEF SUMMARY OF THE INVENTION

To solve the above problem, an objective of the present invention is to provide a power generation system with an agitated plasma-energization equipment to enable stable generation of power.

When the terms “front”, “rear”, “left”, “right”, “up (top)”, “down (bottom)”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

As used herein, the term “one” or “an” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

A power generation system according to the present invention comprises:
an agitated plasma-energization equipment including:
   a furnace including an internal processing space and a gas collection channel intercommunicating with the internal processing space;
   a heating module disposed on the furnace to heat the internal processing space; and
   a gas flow guiding device disposed in the internal processing space and having:
      a first tube which is a hollow casing extending axially and which includes multiple first through holes disposed in a sidewall of the first tube; and
      a second tube which is a hollow casing extending axially and which includes multiple second through holes disposed in a sidewall of the second tube, wherein the first tube is mounted around the second tube, wherein the first tube and the second tube have a gap therebetween, and wherein gas inside the furnace is collected through the gas collection channel and is discharged as a first gas; and
a power generator connected to the agitated plasma-energization equipment, wherein the first gas is transmitted into the power generator, wherein the power generator includes a combustion chamber, a power mechanism, and a power generation unit, wherein the first gas is combusted in the combustion chamber to generate power for driving the power mechanism, and wherein the power generation unit converts kinetic energy of the power mechanism into electric energy.

Thus, in the power generation system with the agitated plasma-energization equipment according to the present invention, through provision of the gas flow guiding device of the agitated plasma-energization equipment, the flammable gas among the materials in the agitated plasma-energization equipment may be discharged easily to avoid explosion of the flammable gas among the materials due to high concentration of the flammable gas, thereby achieving stable discharge of the flammable gas for generating power.

In an example, the power generation system further comprises an electric-energy restoring device coupled with the power generator. The electric-energy restoring device stores electric energy generated by the power generator. Thus, storage of electric energy can be achieved.

In an example, the power generation system further comprises a gas restoring tank connected between the agitated plasma-energization equipment and the power generator. The gas restoring tank stores the first gas discharged from the agitated plasma-energization equipment. Thus, a proper amount of first gas may be stored for the power generator for generating power, thereby stabilizing the production of energy.

In an example, the power generation system further comprises a gas filter disposed between the agitated plasma-energization equipment and the power generator. The gas filter filters the first gas. The first gas enters the power generator after filtration. Thus, the combustion efficiency of the first gas may be increased to enhance the power generation efficiency.

In an example, the power generation system further comprises a gas filter connected to the power generator. The gas filter filters a second gas discharged during a power generation process of the power generator. Thus, the hazardous substances in the second gas may be reduced or removed.

In an example, the power generation system further comprises a fuel supplying tank connected to the power generator. The fuel supplying tank supplies fuel to be combusted by the power generator. Thus, the fuel supplying tank provides additional fuel for mixing with the first gas to increase the combustion efficiency of the combustion chamber of the power generator, thereby enhancing the power generation efficiency.

In an example, the power generation system further comprises a fuel filter connected between the fuel supplying tank and the power generator. The fuel filter filters impurities in the fuel. Thus, the combustion efficiency of the fuel may be increased to enhance the power generation efficiency.

In an example, the power generation system further comprises a heating device connected between the fuel supplying tank and the power generator. The heating device preheats the fuel before the fuel in the fuel supplying tank enters the power generator. Thus, the temperature difference between the fuel and the combustion chamber may be reduced to avoid the fuel having a lower temperature from reducing the overall combustion temperature of the combustion chamber, thereby enhancing the power generation efficiency.

In an example, the first tube includes a first ratchet tooth. The second tube includes a second ratchet tooth. The first ratchet tooth meshes with the second ratchet tooth. When the second tube rotates in a first direction about an axis, the first tube is driven to rotate synchronously. When the second tube rotates in a second direction about the axis, the first tube is driven to jump along the axis. The first direction is one of a clockwise direction and a counterclockwise direction, and the second direction is reverse to the first direction. Thus, through the meshing arrangement between the first ratchet tooth and the second ratchet tooth, the first tube may rotate or jump to stir ambient materials, particularly the materials in the elements or around the structure, such as in the first tube, the multiple first through holes, the second tube, and the second multiple through holes, thereby guiding the gas among the materials. Therefore, flammable gas may flow easily into the gas flow guiding device and then be discharged, which avoids explosion of the flammable gas among the materials due to high concentration of the flammable gas, thereby achieving stable discharge of the flammable gas for generating power.

In an example, the first tube includes an outer tube wall disposed to include radial lengths varying along an axial direction. Thus, when the first tube rotates or jumps, the ambient materials may be stirred more efficiently to guide the gas among the materials. Therefore, the flammable gas may flow easily into the gas flow guiding device and then be discharged, which avoids explosion of the flammable gas among the materials due to high concentration of the flammable gas, thereby achieving stable discharge of the flammable gas for generating power.

### DESCRIPTION OF THE DRAWINGS

FIG. 1 is a schematic diagram illustrating disposition of a power generation system with an agitated plasma-energization equipment according to the present invention.

FIG. 2 is a block diagram of the power generation system of FIG. 1.

FIG. 3 is a cross-sectional view of the structure of a preferred embodiment of the agitated plasma-energization equipment according to the present invention.

FIG. 4 is a cross sectional view of the structure a gas flow guiding device according to the present invention.

FIG. 5 is an enlarged view of a square area A in FIG. 4.

### DETAILED DESCRIPTION OF THE INVENTION

In order to make the above and other objectives, features, and advantages of the present invention clearer and easier to understand, preferred embodiments of the present invention will be described hereinafter in connection with the accompanying drawings. Furthermore, the elements designated by the same reference numeral in various figures will be deemed as identical, and the description thereof will be omitted.

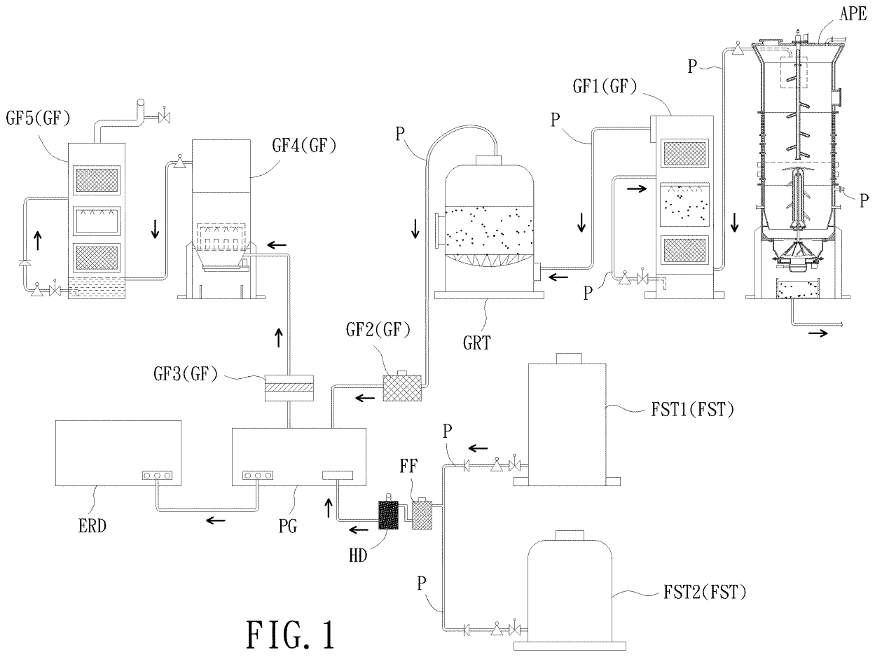

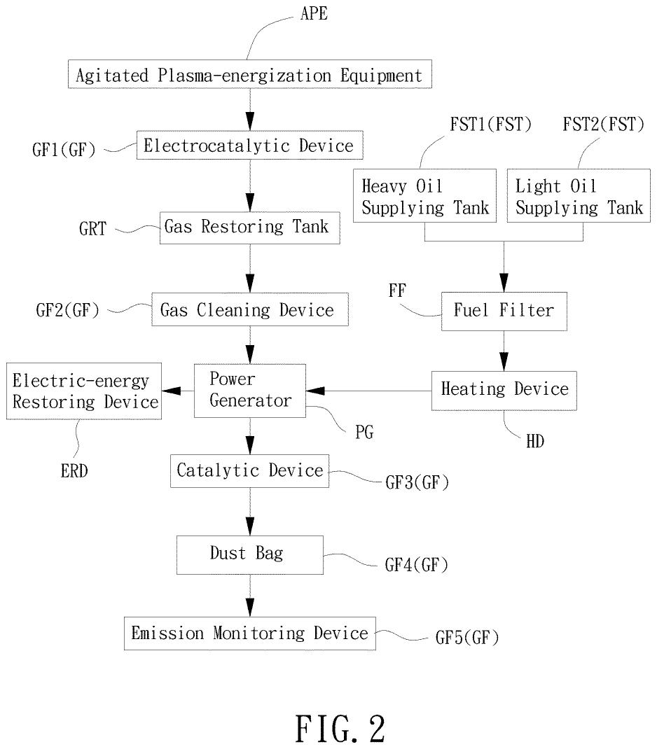

Please refer to FIGS. 1 and 2 which illustrates the disposition of a power generation system with an agitated plasma-energization equipment APE according to the present invention. In an embodiment, the power generation system comprises an agitated plasma-energization equipment APE and a power generator PG.

Optionally, the power generation system may further comprise at least one of the following elements: an electric-energy restoring device ERD, a gas restoring tank GRT, a gas filter GF, and a fuel supplying tank FST.

The specific interactions between the above elements will be described respectively in the description of the present invention hereinafter. Particularly, the following content will firstly describe the specific technology of the agitated plasma-energization equipment APE and then followed by the description of the other elements.

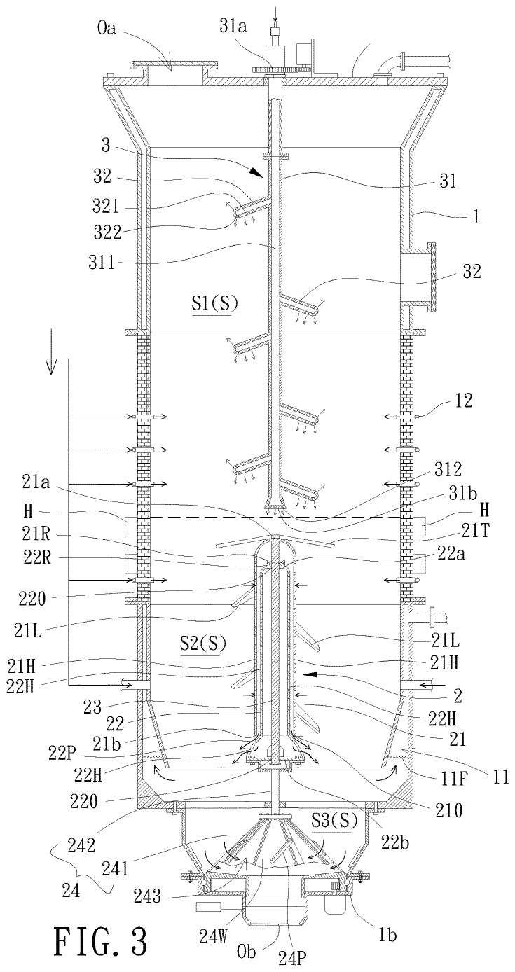

With reference to FIG. 3 showing a preferred embodiment of the agitated plasma-energization equipment APE which comprises a furnace 1, a heating module H, and a gas flow guiding device 2. The heating module H and the gas flow guiding device 2 are mounted to the furnace 1.

The furnace 1 includes an internal processing space S. Specifically, the internal processing space S is configured for stacking materials to be treated and includes a stockpiling area S1, a charcoal slag layer area S2, and an ash accumulation area S3 arranged axially from top to bottom. Particularly, the to-be-treated materials are waste materials, preferably biomass materials/wastes. These materials will be heated in the charcoal slag layer area S2 and turn into treated materials, particularly ashes which are then discharged via the ash accumulation area S3.

Particularly, the furnace 1 includes an interior having a gas collection channel 11 intercommunicating with the internal processing space S. Thus, the gas in the internal processing space S may be discharged through the gas collection channel 11. Optionally, a filtering mesh 11F is disposed in the gas collection channel 11 to filter ash in the gas flowing through the gas collection channel 11.

Specifically, the furnace 1 includes a furnace top end 1a and a furnace bottom end 1b opposite to the furnace top end 1a along an axial direction. A top end opening Oa is provided in the furnace top end 1a, such that the to-be-treated materials may be inputted via the top end opening Oa into the internal processing space S of the furnace 1. A bottom end opening Ob is provided in the furnace bottom end 1b, such that the treated materials (such as ash) in the internal processing space S may be discharged via the bottom end opening Ob.

Optionally, the furnace 1 includes multiple gas inlets 12 to permit supply of air or other combustion accelerants into the internal processing space S, thereby increasing the oxygen content in the materials in the furnace 1 or increasing the combustion efficiency.

The heating module H is mounted to the furnace 1 and is particularly disposed in a location aligned with the internal processing space S for heating the materials in the charcoal slag layer area S2. Optionally, the heating module H may be a microwave equipment. Nevertheless, the present invention is not limited to this example.

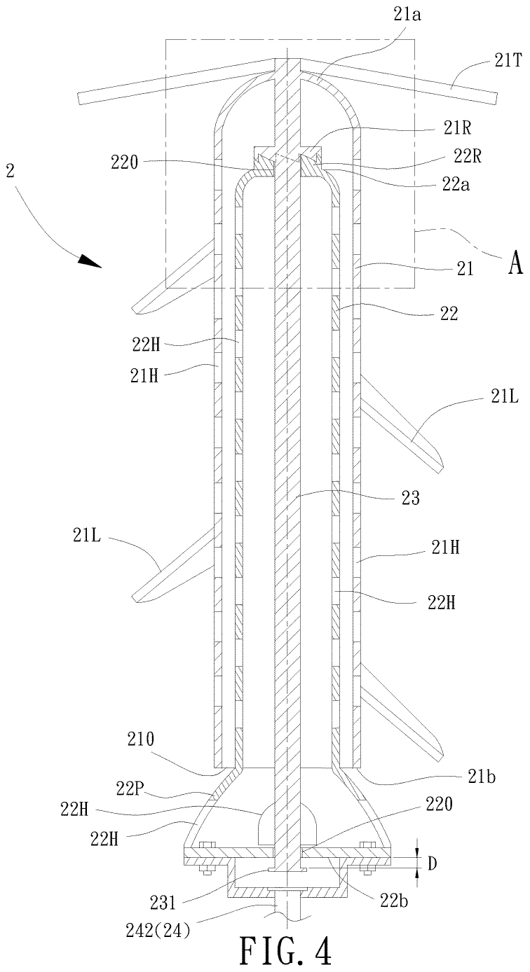

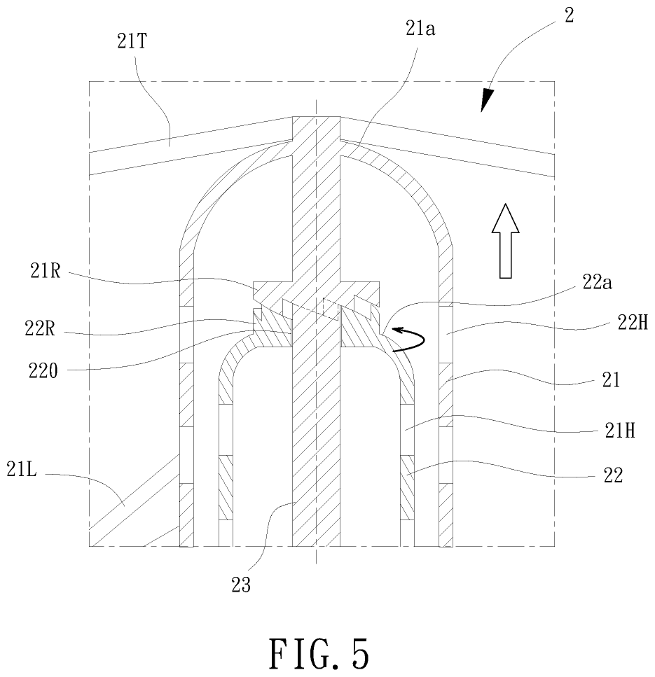

As shown in FIGS. 3-5, the gas flow guiding device 2 is disposed in the internal processing space S and extends from the charcoal slag layer area S2 toward the ash accumulation area S3. The gas flow guiding device 2 includes a first tube 21 and a second tube 22. The first tube 21 extends axially and is a hollow casing. The first tube 21 includes multiple first through holes 21H disposed in a sidewall of the first tube 21. The second tube 22 extends axially and is a hollow casing. The second tube 22 includes multiple second through holes 22H disposed in a sidewall of the second tube 22. The first tube 21 is mounted around the second tube 22. The first tube 21 and the second tube 22 have a gap therebetween, such that the gas may flow from the internal processing space S through the multiple first through holes 21H, the multiple second through holes 22H, the space in the first tube 21, the space in the second tube 22, and the gap. The gas flows in the furnace 1 is collected through the gas collection channel 11 and is preferably subjected to preliminary treatment so as to be discharged as a first gas.

Particularly, as shown in FIGS. 3-5, the first tube 21 includes a first ratchet tooth 21R, and the second tube 22 includes a second ratchet tooth 22R. The first ratchet tooth 21R meshes with the second ratchet tooth 22R, such that when one of the first tube 21 and the second tube 22 rotates in a first direction about an axis, another of the first tube 21 and the second tube 22 is driven to rotate synchronously. In a case that an external resistance imparted to the first tube 21 is greater than a resistance between the first tube 21 and the second tube 22, when one of the first tube 21 and the second tube 22 rotates in a second direction about the axis, the other of the first tube 21 and the second tube 22 is driven to jump or reciprocate along the axis. The first direction is one of a clockwise direction and a counterclockwise direction, and the second direction is reverse to the first direction.

It should be noted that in a practical application in which to-be-treated materials are placed into the internal processing space S, the resistance between the first tube 21 and the materials will be substantially greater than the resistance between the first ratchet tooth 21R and the second ratchet tooth 22R, such that the first tube 21 will jump relative to the second tube 22 when the second tube 22 rotates in the second direction. Thus, the first tube 21 stirs the ambient materials, such that the gas in the internal processing space S may flow easily into the gas flow guiding device 2 and then into the gas collection channel 11, avoiding backdraft resulting from accumulation of flammable gas of an excessively high concentration in the internal processing space S.

Specifically, in an example illustrated in FIGS. 3-5, the first tube 21 includes a first top end 21a and a first bottom end 21b opposite to the first top end 21a along an axial direction. The first tube 21 extends from the first top end 21a toward the first bottom end 21b and forms an opening 210 in the first bottom end 21b. The second tube 22 is mounted in the first tube 21 via the opening 210.

Optionally, the first tube 21 may include an outer tube wall which is disposed to include radial lengths varying along the axial direction. Thus, when the first tube 21 rotates or jumps, the materials on the radial side of the first tube 21 may be pushed to avoid the materials from bridging effect, and the materials may be loosened to enable the gas in the internal processing space S to flow into the gas flow guiding device 2. The arrangement of the varying radial lengths of the first tube 21 along the axial direction may be achieved by disposition of corresponding stirring members. Optionally, the first tube 21 includes a top portion stirring member 21T extending radially outward from the first top end 21a. Optionally, the first tube 21 includes one or more sidewall stirring members 21L extending radially outward from the sidewall of the first tube 21. Optionally, when multiple sidewall stirring members 21L are used, the multiple sidewall stirring members 21L are arranged to be spaced from each other in the axial direction and/or the radial direction, thereby providing a better pushing effect for the materials on the radial side.

Specifically, as shown in FIGS. 3-5, the second tube 22 includes a second top end 22a and a second bottom end 22b opposite to the second top end 22a along the axial direction. The second tube 22 extends from the second top end 22a toward the second bottom end 22b. The second ratchet tooth 22R is provided on an outer wall of the second top end 22a of the second tube 22. When the first tube 21 is mounted around the second tube 22, the first ratchet tooth 21R meshes with the second ratchet tooth 22R to achieve synchronous rotation or relative jumping motion between the first tube 21 and the second tube 22.

Preferably, a portion of the second tube 22 extends axially beyond the first tube 21 to form a protruding portion 22P. The protruding portion 22P includes at least one of the multiple second through holes 22H, preferably plural second through holes 22H. Thus, by the provision of the protruding portion 22P protruding axially beyond the first tube 21, the gas flowing into the gas flow guiding device 2 may flow more easily from the gas flow guiding device 2 into the gas collection channel 11. More preferably, the protruding portion 22P includes increasing radial lengths toward the second bottom end 22b along the axial direction to provide a gradually expanding shape. At least one of the multiple second through holes 22H is disposed in a location of the protruding portion 22P having a larger radial length. Therefore, the location where the gas flows outward is more adjacent to the gas collection channel 11, and the gas flows toward the gas collection channel 11, which assists the gas in flowing into the gas collection channel 11. Particularly, the gradually expanding shape of the protruding portion 22P enables the gas flowing out of the opening 210 to flow radially outward along the gradually expanding shape of the protruding portion 22P, such that the gas flows toward the gas collection channel 11, which assists the gas in flowing into the gas collection channel 11.

In an example, to stabilize the meshing relationship between the first ratchet tooth 21R and the second ratchet tooth 22R, the first tube 21 may further include an axle 23. Each of the second top end 22a and the second bottom end 22b of the second tube 22 has an axial hole 220. The axle 23 extends through each axial hole 220. Particularly, the first tube 21 and the first ratchet tooth 21R may have corresponding axial holes through which the axle 23 extends to form an integral object. Furthermore, the second ratchet tooth 22R may include a corresponding axial hole through which the axle 23 movably extends. Preferably, the axle 23 includes an enlarged portion 231 on an end thereof extending beyond the second bottom end 22b via the axial hole 220. A radial length of the enlarged portion 231 is greater than a radial length of the axial hole 220 to avoid the axle 23 from disengaging from the axial hole 220 of the second bottom end 22b during movement, thereby maintaining the connection relationship between the first ratchet tooth 21R and the second ratchet tooth 22R. Particularly, the enlarged portion 231 and the second bottom end 22b have a spacing D therebetween along the axial direction. The spacing D is not smaller than the jumping distance of the first ratchet tooth 21R relative to the second ratchet tooth 22R along the axial direction.

Optionally, the gas flow guiding device 2 further includes a bottom extension 24 mounted to the second bottom end 22b of the second tube 22. Preferably, the bottom extension 24 includes a bottom member 241 and an optional extension 242. The radial length of the bottom member 241 increases gradually from the second bottom end 2b toward the furnace bottom end 1b. The bottom member 241 includes multiple bottom walls 24W alternatingly disposed with respect to multiple bottom openings 243. Each bottom wall 24W includes a radial protruding portion 24P for pushing ambient material (such as ash) when the bottom extension 24 rotates, thereby guiding the corresponding material from the bottom opening 243 to be discharged via the bottom end opening Ob of the furnace 1. The extension 242 is connected to the second tube 22 and the bottom member 241. Particularly, the extension 242 has a proper length to enable the bottom member 241 and the second tube 22 to be disposed in a proper location of the furnace 1.

Optionally, as shown in FIG. 3, the agitated plasma-energization equipment APE may further comprise a stirring device 3. The stirring device 3 includes a stirring member 31 disposed in the internal processing space S of the furnace 1 and preferably axially extending in the stockpiling area S1. Furthermore, the stirring member 31 includes a first fluid passageway 311 and at least one first output passageway 312, both of which are hollow. Thus, the gas inputted into the first fluid passageway 311 is permitted to be outputted via the at last one first output passageway 312. In an example, the stirring member 31 includes a first end 31a and a second end 31b opposite to the first end 31a. The first end 31a is adjacent to the furnace top end 1a. The second end 31b is distant to the furnace top end 1a. The at least one first output passageway 312 is disposed on the second end 31b of the stirring member 31. Particularly, the stirring device 3 may rotate about the axial direction of the furnace 1.

Preferably, the stirring member 31 includes at least one stirring portion 32 extending radially outward from the stirring member 31. Particularly, when the stirring member 31 includes multiple stirring portions 32, the multiple stirring portions 32 are disposed to be spaced from each other along the axial direction and/or the radial direction. Preferably, each stirring portion 32 includes at least one second fluid passageway 321 and at least one second output passageway 322, both of which are hollow. The at least one second fluid passageway 321 intercommunicates with the first fluid passageway 311, such that the gas inputted into the first fluid passageway 311 is permitted to flow into each second fluid passageway 321 and then outputted via a corresponding second output passageway 322. Particularly, when a stirring portion 32 includes multiple second output passageways 322, the passage directions of the multiple second output passageways 322 may be arranged in any desired manner. Preferably, a portion of the multiple second output passageways 322 faces downward, such as toward the furnace bottom end 1b, whereas another portion of the multiple second output passageways 322 faces upward, such as toward the furnace top end 1a.

By the provision of the stirring member 31, when the outputted gas ejects from the first output passageway 312 and the second output passageway 322, the ejected currents may stir ambient materials in the internal processing space S, thereby scattering the materials and avoiding bridging effect of the materials while assisting in an increase in the oxygen content in the materials. Furthermore, by the disposition of each stirring portion 32 extending radially outward from the stirring member 31, when the stirring member 31 rotates about the axis, each stirring portion 32 may scatter the materials and avoid bridging effect of the materials.

According to the disposition of the above agitated plasma-energization equipment APE, the to-be-treated materials are mainly heated in the charcoal slag layer area S2 and turn into pyrolyzed gases after pyrolysis. At this time, the pyrolyzed gases under high temperature will cause acceleration of delocalized electrons in the gases to impact neutral particles in the gases, which turns the electrons and the atomic nucleus of the neutral particles into delocalized electrons. Thus, the respective gases turn into plasma after ionization. The high-energy electrons generated by the discharging of the plasma have a higher energy sufficient to cause breakage or lysis of the chemical bonds in local specific locations of most common pollutant molecules. These gases generated during the heating process will be preliminarily filtered by the respective charcoal slag layer S2 and then undergo composite chemical reactions with the elements generated by the lysis in the charcoal slag layer S2, thereby forming gases free of pollution or with low pollution. Then, these gases are guided by the gas flow guiding device 2 into the gas collection channel 11 and then discharged. Furthermore, the ashes formed under the above mechanism are free of pollution or less polluted, are preferably oxides and salts containing calcium, magnesium, sulfur, potassium, and sodium, and may be used as green carbon, blue carbon, or yellow carbon.

Particularly, the gases discharged by the agitated plasma-energization equipment APE are defined as the first gas. Therefore, the first gas contain many flammable ingredients, such as carbon monoxide, hydrogen, and methane. Thus, the first gas is suitable to be combusted in the power generator PG for generating power, thereby achieving generation of green energy (biomass energy).

Optionally, as shown in FIGS. 1 and 2, the power generator PG is directly or indirectly connected to the agitated plasma-energization equipment APE. Particularly, the first gas discharged by the agitated plasma-energization equipment APE may be directly or indirectly transmitted into the power generator PG via pipes P. Specifically, the power generator PG includes a combustion chamber, a power mechanism, and a power generation unit (not shown). The first gas is combusted in the combustion chamber to generate power for driving the power mechanism. The power generation unit converts kinetic energy of the power mechanism into electric energy. Particularly, after combustion in the combustion chamber, the first gas turn into a second gas discharged by the power generator PG.

Optionally, the power generator PG is coupled with the electric-energy restoring device ERD. The electric-energy restoring device ERD is used to store electric energy generated by the power generator PG.

Optionally, the gas restoring tank GRT is connected between the agitated plasma-energization equipment APE and the power generator PG. The gas restoring tank GRT is used to store the first gas discharged from the agitated plasma-energization equipment APE. When the power generator PG is subsequently used to generate power, the first gas may be stably supplied for power generation.

Optionally, the gas filter GF is disposed between the agitated plasma-energization equipment APE and the power generator PG, or connected to the power generator PG. The gas filter GF filters the first gas or the second gas. The gas filter GF may include at least one of an electrocatalytic device GF1, a gas cleaning device GF2, a catalytic device GF3, a dust bag GF4, and an emission monitoring device GF5.

The electrocatalytic device GF1 is disposed between the agitated plasma-energization equipment APE and the power generator PG, preferably between the agitated plasma-energization equipment APE and the gas restoring tank GRT. The electrocatalytic device GF1 filters particulates in the first gas through action of electricity and spraying water.

The gas cleaning device GF2 is disposed between the agitated plasma-energization equipment APE and the power generator PG, preferably between the gas restoring tank GRT and the power generator PG. The gas cleaning device GF2 is used to remove contaminated substances in the first gas. Particularly, the first gas includes at least hydrogen after treatment by the gas cleaning device GF2.

The catalytic device GF3 is connected to the power generator PG. The catalytic device GF3 is used to turn the contaminated substances (such as hydrocarbons, carbon monoxide, nitrogen oxides) in the second gas into harmless carbon dioxide, water, and nitrogen.

The dust bag GF4 is connected to the power generator PG, preferably to the catalytic device GF3. The dust bag GF4 is used to filter dust in the second gas.

The emission monitoring device GF5 is connected to the power generator PG, preferably to the dust bag GF4. The emission monitoring device GF5 includes a gas detection unit to assure the composition of the second gas meet the quality regulated by the environmental protection rules. Preferably, the emission monitoring device GF5 includes a sprinkling area therein in which purifying water is sprinkled. The purifying water contains ingredients for removing hazardous substances, such as nitrogen oxides or sulfides which are harmful to the human body. The ingredients may be adjusted according to the hazardous substances in the second gas, and the hazardous substances are not limited to those mentioned in the above example.

Optionally, the fuel supplying tank FST is connected to the power generator PG and is used to supply the power generator PG with the fuel required for combustion. The fuel provided by the fuel supplying tank FST may be oil, particularly recycled oil. The oil is mixed with the first gas, and combustion is then conducted in the combustion chamber of the power generator PG, thereby enhancing the efficiency of the power generator PG. Optionally, the fuel supplying tank FST may include a heavy oil supplying tank FST1 and/or a light oil supplying tank FST2. The oil supplied by the heavy oil supplying tank FST1 is heavy oil, such as oil obtained from refining recycled motor oil, gear oil, or fuel oil. The oil supplied by the light oil supplying tank FST2 is light oil, such as oil obtained from refining recycled industrial solvents or process oil.

Preferably, a fuel filter FF is connected between the fuel supplying tank FST and the power generator PG. The fuel filter FF is used to filter impurities in the fuel.

Preferably, a heating device HD is connected between the fuel supplying tank FST and the power generator PG, preferably between the fuel filter FF and the power generator PG. The heating device HD is used to preheat the fuel before the fuel enters the combustion chamber of the power generator PG, thereby enhancing the power generation efficiency.

It is noted that the transmission of the first gas, the second gas, the fuel/oil in the elements may be achieved by the pipes P disposed among the elements.

In summary, in the power generation system with the agitated plasma-energization equipment APE according to the present invention, through provision of the gas flow guiding device 2 of the agitated plasma-energization equipment APE, the flammable gas among the materials in the agitated plasma-energization equipment APE may be discharged easily to avoid explosion of the flammable gas among the materials due to high concentration of the flammable gas, thereby achieving stable discharge of the flammable gas for generating power.

Although the present invention has been described with respect to the above preferred embodiments, these embodiment are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims. Furthermore, in a case that several of the above embodiments can be combined, the present invention includes the implementation of any combination.

1. A power generation system comprising:
an agitated plasma-energization equipment including:
a furnace including an internal processing space and a gas collection channel intercommunicating with the internal processing space;
a heating module disposed on the furnace to heat the internal processing space; and
a gas flow guiding device disposed in the internal processing space and having:
a first tube which is a hollow casing extending axially and which includes multiple first through holes disposed in a sidewall of the first tube; and
a second tube which is a hollow casing extending axially and which includes multiple second through holes disposed in a sidewall of the second tube, wherein the first tube is mounted around the second tube, wherein the first tube and the second tube have a gap therebetween, and wherein gas inside the furnace is collected through the gas collection channel and is discharged as a first gas; and
a power generator connected to the agitated plasma-energization equipment, wherein the first gas is transmitted into the power generator, wherein the power generator includes a combustion chamber, a power mechanism, and a power generation unit, wherein the first gas is combusted in the combustion chamber to generate power for driving the power mechanism, and wherein the power generation unit converts kinetic energy of the power mechanism into electric energy.

2. The power generation system as claimed in claim 1, further comprising an electric-energy restoring device coupled with the power generator, wherein the electric-energy restoring device stores electric energy generated by the power generator.

3. The power generation system as claimed in claim 1, further comprising a gas restoring tank connected between the agitated plasma-energization equipment and the power generator, wherein the gas restoring tank stores the first gas discharged from the agitated plasma-energization equipment.

4. The power generation system as claimed in claim 1, further comprising a gas filter disposed between the agitated plasma-energization equipment and the power generator, wherein the gas filter filters the first gas, and the first gas enters the power generator after filtration.

5. The power generation system as claimed in claim 1, further comprising a gas filter connected to the power generator, wherein gas filter filters a second gas discharged during a power generation process of the power generator.

6. The power generation system as claimed in claim 1, further comprising a fuel supplying tank connected to the power generator, wherein the fuel supplying tank supplies fuel to be combusted by the power generator.

7. The power generation system as claimed in claim 6, further comprising a fuel filter connected between the fuel supplying tank and the power generator, wherein the fuel filter filters impurities in the fuel.

8. The power generation system as claimed in claim 6, further comprising a heating device connected between the fuel supplying tank and the power generator, wherein the heating device preheats the fuel before the fuel in the fuel supplying tank enters the power generator.

9. The power generation system as claimed in claim 1, wherein the first tube includes a first ratchet tooth, wherein the second tube includes a second ratchet tooth, wherein the first ratchet tooth meshes with the second ratchet tooth, such that when the second tube rotates in a first direction about an axis, the first tube is driven to rotate synchronously, and when the second tube rotates in a second direction about the axis, the first tube is driven to jump along the axis, wherein the first direction is one of a clockwise direction and a counterclockwise direction, and the second direction is reverse to the first direction.

10. The power generation system as claimed in claim 2, wherein the first tube includes a first ratchet tooth, wherein the second tube includes a second ratchet tooth, wherein the first ratchet tooth meshes with the second ratchet tooth, such that when the second tube rotates in a first direction about an axis, the first tube is driven to rotate synchronously, and when the second tube rotates in a second direction about the axis, the first tube is driven to jump along the axis, wherein the first direction is one of a clockwise direction and a counterclockwise direction, and the second direction is reverse to the first direction.

11. The power generation system as claimed in claim 3, wherein the first tube includes a first ratchet tooth, wherein the second tube includes a second ratchet tooth, wherein the first ratchet tooth meshes with the second ratchet tooth, such that when the second tube rotates in a first direction about an axis, the first tube is driven to rotate synchronously, and when the second tube rotates in a second direction about the axis, the first tube is driven to jump along the axis, wherein the first direction is one of a clockwise direction and a counterclockwise direction, and the second direction is reverse to the first direction.

12. The power generation system as claimed in claim 4, wherein the first tube includes a first ratchet tooth, wherein the second tube includes a second ratchet tooth, wherein the first ratchet tooth meshes with the second ratchet tooth, such that when the second tube rotates in a first direction about an axis, the first tube is driven to rotate synchronously, and when the second tube rotates in a second direction about the axis, the first tube is driven to jump along the axis, wherein the first direction is one of a clockwise direction and a counterclockwise direction, and the second direction is reverse to the first direction.

13. The power generation system as claimed in claim 5, wherein the first tube includes a first ratchet tooth, wherein the second tube includes a second ratchet tooth, wherein the first ratchet tooth meshes with the second ratchet tooth, such that when the second tube rotates in a first direction about an axis, the first tube is driven to rotate synchronously, and when the second tube rotates in a second direction about the axis, the first tube is driven to jump along the axis, wherein the first direction is one of a clockwise direction and a counterclockwise direction, and the second direction is reverse to the first direction.

14. The power generation system as claimed in claim 6, wherein the first tube includes a first ratchet tooth, wherein the second tube includes a second ratchet tooth, wherein the first ratchet tooth meshes with the second ratchet tooth, such that when the second tube rotates in a first direction about an axis, the first tube is driven to rotate synchronously, and when the second tube rotates in a second direction about the axis, the first tube is driven to jump along the axis, wherein the first direction is one of a clockwise direction and a counterclockwise direction, and the second direction is reverse to the first direction.

15. The power generation system as claimed in claim 7, wherein the first tube includes a first ratchet tooth, wherein the second tube includes a second ratchet tooth, wherein the first ratchet tooth meshes with the second ratchet tooth, such that when the second tube rotates in a first direction about an axis, the first tube is driven to rotate synchronously, and when the second tube rotates in a second direction about the axis, the first tube is driven to jump along the axis, wherein the first direction is one of a clockwise direction and a counterclockwise direction, and the second direction is reverse to the first direction.

16. The power generation system as claimed in claim 8, wherein the first tube includes a first ratchet tooth, wherein the second tube includes a second ratchet tooth, wherein the first ratchet tooth meshes with the second ratchet tooth, such that when the second tube rotates in a first direction about an axis, the first tube is driven to rotate synchronously, and when the second tube rotates in a second direction about the axis, the first tube is driven to jump along the axis, wherein the first direction is one of a clockwise direction and a counterclockwise direction, and the second direction is reverse to the first direction.

17. The power generation system as claimed in claim 9, wherein the first tube includes an outer tube wall disposed to include radial lengths varying along an axial direction.

18. The power generation system as claimed in claim 10, wherein the first tube includes an outer tube wall disposed to include radial lengths varying along an axial direction.

19. The power generation system as claimed in claim 11, wherein the first tube includes an outer tube wall disposed to include radial lengths varying along an axial direction.

20. The power generation system as claimed in claim 12, wherein the first tube includes an outer tube wall disposed to include radial lengths varying along an axial direction.

21. The power generation system as claimed in claim 13, wherein the first tube includes an outer tube wall disposed to include radial lengths varying along an axial direction.

22. The power generation system as claimed in claim 14, wherein the first tube includes an outer tube wall disposed to include radial lengths varying along an axial direction.

23. The power generation system as claimed in claim 15, wherein the first tube includes an outer tube wall disposed to include radial lengths varying along an axial direction.

24. The power generation system as claimed in claim 16, wherein the first tube includes an outer tube wall disposed to include radial lengths varying along an axial direction.
